(19) United States
(12) Patent Application Publication
(10) Pub. No.: US 2014/0279734 A1
(43) Pub. Date: Sep. 18, 2014

(54) Performing Cross-Validation Using Non-Randomly Selected Cases

(71) Applicant: HEWLETT-PACKARD DEVELOPMENT COMPANY, L.P., Houston, TX (US)

(72) Inventor: George Forman, Port Orchard, WA (US)

(73) Assignee: Hewlett-Packard Development Company, L.P., Houston, TX (US)

(21) Appl. No.: 13/832,805

(22) Filed: Mar. 15, 2013

(51) Int. Cl. G06N 99/00

(52) U.S. Cl. CPC G06N 99/005
USPC 706/12

(57) ABSTRACT

A technique to perform cross-validation using a set of randomly selected labeled cases and a set of non-randomly selected labeled cases. A training set for use during cross-validation can include cases from both sets. A test set for use during cross-validation can include cases from the randomly selected set but exclude cases from the non-randomly selected set.

### BACKGROUND

In machine learning, developing a classifier can be a difficult, expensive, and time-consuming process. Labeled cases are used to train and test a classifier. Cases can be selected for labeling from a case population using various methods. For example, cases can be selected using a random sampling technique, in which cases are randomly selected from the population. In addition, cases can be selected using a non-random sampling technique. For example, cases can be selected using an active learning technique, in which cases are specifically selected based on one or more characteristics. Selecting cases with such a method can reduce the amount of training time used to develop an accurate classifier since sampling can be focused near a decision boundary of the classifier. Regardless of method of selection, the cases can then be labeled for use in developing the classifier. Labeling cases can be an expensive, time-consuming, and difficult task.

### BRIEF DESCRIPTION OF DRAWINGS

The following detailed description refers to the drawings, wherein:

FIG. 1 illustrates a method of performing cross-validation, according to an example.

FIG. 2 illustrates an example of a case population and a sampling distribution, according to an example.

FIG. 3 illustrates a method of performing a modified version of k-fold cross-validation, according to an example.

FIGS. 4(a) and 4(b) illustrate examples of dividing sets of cases into folds, according to an example.

FIG. 5 illustrates a system for performing cross-validation, according to an example.

FIG. 6 illustrates a computer-readable medium for performing cross-validation, according to an example.

### DETAILED DESCRIPTION

According to an embodiment, cross-validation techniques can be used with a set of labeled cases that includes non-randomly selected cases in addition to randomly selected cases.

Cross-validation is a technique that can be used to aid in model selection and/or parameter tuning when developing a classifier. Cross-validation uses one or more subsets of cases from the set of labeled cases as a test set. For example, in k-fold cross-validation, a set of labeled cases is equally divided into k “folds.” A series of train-then-test cycles is performed, iterating through the k folds such that in each cycle a different fold is used as a test set while the remaining folds are used as the training set. Since each fold is used as the test set at some point, including non-randomly selected cases in the set of labeled cases would seemingly bias the cross-validation. Accordingly, techniques such as active learning, which non-randomly select cases from a population, could be considered to be incompatible with cross-validation.

Disclosed herein is a technique of benefiting from both cross-validation techniques and non-random sampling techniques. This technique may be used to avoid testing bias that may result due to the inclusion of the non-randomly selected cases in the labeled set. In an example, cross-validation can be performed by excluding the non-randomly selected cases from the test set. Accordingly, a classifier can be trained on a training set that includes both randomly selected cases and non-randomly selected cases. The classifier can then be tested on a test set that includes randomly selected cases but excludes (i.e., does not include) non-randomly selected cases.

Accordingly, one may receive the benefits of both cross-validation and non-random sampling when developing a classifier. Among the benefits of cross-validation is the efficient use of labeled cases. Without cross-validation, it may be that more labeled cases are required for selecting an appropriate classifier model or tuning a particular classifier's parameters. Further, as noted above, non-random sampling techniques, such as active learning, can have the advantage of reducing the time used to develop an accurate classifier. Additional examples, advantages, features, modifications and the like are described below with reference to the drawings.

FIG. 1 illustrates a method of performing cross-validation, according to an example. Method 100 may be performed by a computing device, system, or computer, such as computing system 500 or computer 600. Computer-readable instructions for implementing method 100 may be stored on a computer readable storage medium. These instructions as stored on the medium are referred to herein as “modules” and may be executed by a computer.

Method 100 may begin at 110, where a classifier can be trained on a training set. The training set can include both randomly selected labeled cases and non-randomly selected labeled cases. The randomly selected labeled cases may constitute a first set and the non-randomly selected labeled cases may constitute a second set. These sets may be stored in memory in such a way that they are distinguishable from each other.

Both sets of cases may be sampled from the same population of cases. The population of cases may represent a distribution of cases likely to be encountered by the classifier when it is deployed. For example, the population may include cases that have previously been encountered in a production environment. For instance, if the classifier is being trained to classify email as “spam” or “not spam”, the population of cases may include actual emails that have been received in the past. The population may also include cases generated for the purpose of developing the classifier. Referring again to an email example, the population may include emails that have been intentionally generated by a computer or person to represent the type of emails likely to be encountered in a production environment.

The cases sampled from the population may or may not be labeled at the time of sampling. A case is considered to be labeled if it has already been classified by an expert (e.g., a particular email being labeled as “spam” or “not spam”). An expert may be a person or a computer. For example, an expert may be a person with a particular expertise or training in a specific domain to which the cases relate. This person may assign the appropriate classification to cases. The expert may also be a person without particular expertise or training in the specific domain to which the cases relate. The expert may also be a program executed by a computer. For example, the expert may be a classifier that has been trained to label cases. In the case where the cases were intentionally generated for development of a classifier, the cases may be assigned a label at the time of generation. On the other hand, if the cases have not been classified by an expert, the cases are considered to be unlabeled. In such a case, selected cases may be labeled by an expert after they have been selected.

Cases may be selected from the population in various ways. The randomly selected cases may be selected using a random sampling technique. Random sampling may be performed by randomly sampling cases from the population. A computer may perform random sampling using a random-sampling algorithm. Such algorithms may incorporate random number generators so as to randomly sample cases from a population. Additionally, if all of the available cases from a population are sampled, such sampling is considered herein to be by a random sampling technique. In such a case, additional cases may be later sampled from the population as they become available. Such additional cases may also be sampled by a random sampling technique or by another sampling technique.

The non-randomly selected cases may be selected using a non-random sampling technique. Various non-random sampling techniques exist. For example, the cases may be sampled using an active learning technique. An active learning technique selects cases from a population based on one or more characteristics of the cases. For instance, an active learning algorithm may be designed to select cases in a population whose features place the case near a decision boundary of the classifier. Such cases may be selected because cases near the decision boundary are, by definition, more difficult to classify, and so the accuracy of the classifier may be improved by requesting the classification of those cases. Cases selected using an active learning technique are referred to herein as “actively selected cases” and, if they are labeled, as “actively selected labeled cases”. Another technique for non-random sampling is user-specified selection of cases. For example, if the cases in the population are textual, the user may perform a search to identify cases having a particular keyword. Similarly, the user may search cases based on other attributes, such as particular numeral values associated with features of the cases, or the like.

Briefly turning to FIG. 2, plots 200 and 250 illustrate some of the effects of using particular sampling techniques. Plot 200 illustrates an example population of cases and plot 250 illustrates two example distributions of cases based on sampling technique.

Plot 200 depicts a two-dimensional feature space containing a population 210 of cases. As can be seen, the cases in population 210 are unevenly distributed. The cases are depicted as being classified as positive (+) or negative (−). Case 220 is an example of a positive case, while case 230 is an example of a negative case. These designations are intended to correspond with the manner in which the cases should be classified by a classifier (or in different words, the manner in which the cases should be labeled). Dotted line 240 illustrates a decision boundary that may be associated with a classifier. A decision boundary represents the function learned by a classifier for the purpose of classifying cases in a particular distribution.

Plot 250 depicts an example distribution 260 and an example distribution 270 of cases sampled from population 210. Distribution 260 represents an example distribution of cases that may be sampled using a random sampling technique. As would be expected, more cases are sampled from those areas of the population 210 having more cases. On the other hand, distribution 270 represents an example distribution of cases that may be sampled using an active learning technique (i.e., a non-random sampling technique). As would be expected, more cases are sampled near the decision boundary 240 than far from the decision boundary 240.

Both sampling techniques have their merits. Random sampling may be more likely to result in a representative sample of the population. However, if the cases are distributed more heavily far from a decision boundary (as shown in plot 200), time and money may be spent processing the large number of cases sampled from such areas without achieving a strong return in terms of classifier accuracy. Non-random sampling may be more likely to focus on certain types of cases, such as those near a decision boundary, resulting in quicker training of a classifier. However, as discussed previously, the non-random selection of such cases can cause bias problems when using a technique such as cross-validation.

Returning to FIG. 1, method 100 can take advantage of cases sampled using both techniques by training the classifier on a training set that includes both randomly selected labeled cases and non-randomly selected labeled cases. Specifically, the training set may include a first subset of the set of randomly selected labeled cases. The training set may also include a subset of the non-randomly selected labeled cases. In some examples, the subset of non-randomly selected cases may be the entire set of non-randomly selected cases.

Method 100 may continue to 120, where the performance of the classifier may be measured on a test set. The test set may include a second subset of the set of randomly selected labeled cases that is disjoint relative to the first subset of the set of randomly selected labeled cases. Furthermore, the test set may exclude all cases from the set of non-randomly selected labeled cases. In other words, the test set may include no cases from the set of randomly selected labeled cases. By excluding the non-randomly selected labeled cases from the test set, the performance measurement of the classifier on the test set may be considered unbiased (since all cases in the test set were randomly sampled from the population).

As shown in FIG. 3, method 100 may be modified to perform a modified version of k-fold cross-validation, according to an example. Method 300 may be performed by a computing device, system, or computer, such as computing system 500 or computer 600. Computer-readable instructions for implementing method 300 may be stored on a computer readable storage medium. These instructions as stored on the medium are referred to herein as “modules” and may be executed by a computer.

Method 300 may begin at 310, where the randomly selected labeled cases are divided into k folds. As shown in FIG. 4(a), the randomly selected labeled cases (set 1) may be divided into four folds (k=4). Each fold may have an equal number of cases (or close to equal, such as when the number of cases does not divide evenly). At 320, one of the four folds (e.g., fold 1) may be assigned to be the test set. The set of non-randomly selected labeled cases may be excluded from the test set. At 330, the remaining folds (e.g., folds 2-4) may be assigned to be the training set. At 340, a subset of the non-randomly selected labeled cases may be added to the training set. In some examples, the subset of the non-randomly selected labeled cases may include the entire set of non-randomly selected labeled cases.

At 350, training may be performed using the training set. In particular, a classifier may be trained using the training set. At 360, testing may be performed using the test set. In particular, the performance of the classifier may be measured using the test set. 320-360 may then be repeated until each fold of the k folds is used as the test set. For example, 320-360 may be performed for a total of k iterations. During each iteration, a new classifier may be trained using the same classifier model or parameter tuning. The measured performance for each iteration may then be averaged at the end of method 300 to provide a performance measure for the particular classifier model or parameter tuning.

In an example, the set of non-randomly selected labeled cases may be divided into k folds as well. FIG. 4(b) illustrates two sets, set 1 and set 2. Set 1 may correspond to the randomly selected labeled cases. Set 2 may correspond to the non-randomly selected labeled cases. Both sets may be divided into k folds. Set 1 can be processed as shown in FIG. 3. For set 2, the fold in set 2 corresponding to the fold in set 1 being currently used as the test set may be excluded from the training set. The remaining folds may constitute the subset of the non-randomly selected labeled cases. Accordingly, for example, when fold 1 of set 1 is being used as the test set, fold 1 of set 2 may be excluded from the training set. However, fold 1 of set 2 (and the other folds of set 2, as well) will still be excluded from the test set. In this way, the training set in each iteration of the k-fold cross validation will be independent of a portion of the non-randomly selected labeled cases.

In an example, the cross-validation used in methods 100, 300 may be used to evaluate classifier models. For example, methods 100, 300 may be performed on a first classifier based on a first classifier model, such as a Support Vector Machine model. Methods 100, 300 may then be performed on a second classifier based on a second classifier model, such as a naïve Bayes model. The classifier model associated with the classifier having the best measured performance may then be selected for development of a production classifier (i.e., the classifier intended to be used in a production environment).

In another example, the cross-validation used in methods 100, 300 may be used for parameter tuning of a classifier. For example, methods 100, 300 may be performed on a first classifier having a first set of parameter values. Methods 100, 300 may then be performed on a second classifier having a second set of parameter values. The parameter values associated with the classifier having the best measured performance may then be selected for development of a production classifier.

In another example, cross-validation phases employing method 100, 300 may be alternated with non-random sampling phases (e.g., active learning phases). For example, during an active learning phase, at least one case may be selected for labeling. The selected at least one case may then be labeled by an expert. The labeled, selected at least one case may then be added to the set of non-randomly selected labeled cases.

FIG. 5 illustrates a system for performing cross-validation, according to an example. Computing system 500 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 500 may include one or more machine-readable storage media separate from the one or more controllers, such as memory 510.

Computing system 500 may include memory 510, cross-validation module 520, labeling module 530, and classifier module 540. Each of these components may be implemented by a single computer or multiple computers. The components may include software, one or more machine-readable media for storing the software, and one or more processors for executing the software. Software may be a computer program comprising machine-executable instructions.

In addition, users of computing system 500 may interact with computing system 500 through one or more other computers, which may or may not be considered part of computing system 500. As an example, a user may interact with system 500 via a computer application residing on system 500 or on another computer, such as a desktop computer, workstation computer, tablet computer, or the like. The computer application can include a user interface.

Computer system 500 may perform methods 100, 300, and variation thereof, and components 520-540 may be configured to perform various portions of methods 100, 300, and variation thereof. Additionally, the functionality implemented by components 520-540 may be part of a larger software platform, system, application, or the like. For example, these components may be part of a data analysis system.

In an example, memory 510 may be configured to store a first set of randomly sampled labeled cases 512 and a second set of non-randomly sampled labeled cases. The second set of cases may include cases sampled using an active learning technique. Cross-validation module 520 may be configured to perform cross-validation using the first and second sets of cases. For example, the cross-validation module 520 may be configured to exclude the second set of cases from a test set used in a test phase of the cross-validation. The test phase of the cross-validation may correspond to 120 in method 100 and 360 in method 300. Additionally, the cross-validation module may be configured to include a subset of the second set of cases in a training set used in a training phase of the cross-validation. The training phase of the cross-validation may correspond to 110 in method 100 and 350 in method 300. The subset of the second set of cases may include the entire second set of cases.

Additionally, labeling module 530 may be configured to generate the second set of non-randomly sampled labeled cases by requesting that an expert assign labels to non-randomly sampled non-labeled cases selected from a population. Classifier module 540 may be configured to generate at least one classifier based on the first and second sets. Cross-validation module 520 may be configured to perform the cross-validation on the generated classifier(s).

FIG. 6 illustrates a computer-readable medium for performing cross-validation, according to an example. Computer 600 may be any of a variety of computing devices or systems, such as described with respect to computing system 500.

Computer 600 may have access to database 630. Database 630 may include one or more computers, and may include one or more controllers and machine-readable storage mediums, as described herein. Computer 600 may be connected to database 630 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 610 may be at least one central processing unit (CPU), at least one semiconductor-based microprocessor, other hardware devices or processing elements suitable to retrieve and execute instructions stored in machine-readable storage medium 620, or combinations thereof. Processor 610 can include single or multiple cores on a chip, multiple cores across multiple chips, multiple cores across multiple devices, or combinations thereof. Processor 610 may fetch, decode, and execute instructions 622, 624 among others, to implement various processing. As an alternative or in addition to retrieving and executing instructions, processor 610 may include at least one integrated circuit (IC), other control logic, other electronic circuits, or combinations thereof that include a number of electronic components for performing the functionality of instructions 622, 624. Accordingly, processor 610 may be implemented across multiple processing units and instructions 622, 624 may be implemented by different processing units in different areas of computer 600.

Machine-readable storage medium 620 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 620 can be computer-readable and non-transitory. Machine-readable storage medium 620 may be encoded with a series of executable instructions for managing processing elements.

The instructions 622, 624 when executed by processor 610 (e.g., via one processing element or multiple processing elements of the processor) can cause processor 610 to perform processes, for example, methods 100, 300, and variations thereof. Furthermore, computer 600 may be similar to computing system 500 and may have similar functionality and be used in similar ways, as described above.

For example, training instructions 622 may cause processor 610 to train a classifier on a training set including a first subset of a first set 632 of randomly selected labeled cases and a subset of a second set 634 of actively selected labeled cases. The subset of the second set of actively selected labeled cases may include the entire second set. Measuring instructions 624 may cause processor 610 to measure the performance of the classifier on a test set comprising a second subset of the first set, where the test set excludes actively selected cases. The second subset of the first set may be disjoint relative to the first subset of the first set. Furthermore, the instructions may cause processor 610 to perform a modified version of k-fold cross-validation on the first set of randomly selected labeled cases and the second set of actively labeled cases such that the test set in each iteration of the modified version of k-fold cross-validation excludes cases from the second set.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method for performing cross-validation, comprising:
given a first set of randomly selected labeled cases and a second set of actively selected labeled cases,
training a classifier on a training set comprising a first subset of the first set and a subset of the second set; and
measuring the performance of the classifier on a test set comprising a second subset of the first set that is disjoint relative to the first subset, the test set including no cases from the second set.

2. The method of claim 1, wherein the cross-validation is a version of k-fold cross-validation modified to accommodate active learning.

3. The method of claim 2, further comprising excluding the second set from the test set during each iteration of the modified version of k-fold cross-validation.

4. The method of claim 2, wherein the modified version of k-fold cross-validation comprises:
(a) dividing the first set into k folds;
(b) assigning a fold of the k folds to be the test set;
(c) assigning the remaining folds to be the training set;
(d) adding the subset of the second set to the training set;
(e) performing the training using the training set,
(f) performing the measuring using the test set; and
(g) repeating (b) through (f) until each fold of the k folds has been used as the test set.

5. The method of claim 2, further comprising:
dividing the second set into k folds;
selecting a fold of the k folds; and
excluding the selected fold from the training set during a corresponding iteration of the k-fold cross-validation, wherein the remaining folds constitute the subset of the second set.

6. The method of claim 1, wherein the subset of the second set comprises the entire second set.

7. The method of claim 1, further comprising:
performing active learning phases alternately with cross-validation phases; and
adding any cases labeled during the active learning phases to the second set.

8. The method of claim 1, further comprising:
selecting at least one case from a set of unlabeled cases for labeling during an active learning phase;
labeling the selected at least one case; and
adding the labeled, selected at least one case to the second set.

9. The method of claim 1, further comprising:
training a second classifier on the training set;
measuring the performance of the second classifier on the test set; and
selecting one of the classifier and the second classifier based on the measured performance of each.

10. A system, comprising:
a memory to store a first set of randomly sampled labeled cases and a second set of non-randomly sampled labeled cases; and
a cross-validation module to perform cross-validation using the first and second sets of cases, the cross-validation module configured to exclude the second set of non-randomly sampled labeled cases from a test set used in a test phase of the cross-validation.

11. The system of claim 10, wherein the second set of non-randomly sampled labeled cases is sampled using an active learning technique.

12. The system of claim 10, further comprising:
a labeling module to generate the second set of non-randomly sampled labeled cases by requesting that an expert assign labels to non-randomly sampled non-labeled cases selected from a population; and
a classifier module to generate at least one classifier based on the first and second sets,
wherein the cross-validation module is configured to perform the cross-validation on the generated at least one classifier.

13. The system of claim 10, wherein the cross-validation module is configured to include a subset of the second set of non-randomly sampled labeled cases in a training set used in a training phase of the cross-validation.

14. A non-transitory computer readable storage medium storing instructions that, when executed by a processor, cause a computer to perform cross-validation as follows:
train a classifier on a training set comprising a first subset of a first set of randomly selected labeled cases and a subset of a second set of actively selected labeled cases; and
measure the performance of the classifier on a test set comprising a second subset of the first set, the test set excluding actively selected cases.

15. The storage medium of claim 14, further comprising instructions that, when executed by a processor, cause the computer to:
perform a modified version of k-fold cross-validation on the first set of randomly selected labeled cases and the second set of actively labeled cases such that the test set in each iteration of the modified version of k-fold cross-validation excludes cases from the second set.
